(19) United States
(12) Patent Application Publication
(10) Pub. No.: US 2006/0012548 A1
(43) Pub. Date: Jan. 19, 2006

(54) Method and device for driving display panel

(75) Inventor: Masahiro Suzuki, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/177,484

(22) Filed: Jul. 11, 2005

(30) Foreign Application Priority Data
Jul. 13, 2004 (JP) 2004-205683

(51) Int. Cl. G09G 3/28

(52) U.S. Cl. 345/63

(57) ABSTRACT

A driving method comprises the steps of: (a) when a display cell is lit at a brightness of (α+k×n)th grayscale level, turning ON display cells not only in a sub-field period in which a display cell is lit at a brightness of (α+K×(n−1))th grayscale level, but also in other sub-field periods; and (b) when a display cell is lit at a brightness of an intermediate level between (α+K×(n−1))th grayscale level and (α+K×n)th grayscale level, setting display cells to be a opposite state of a turned ON or turned OFF state at (α+K×(n−1))th or (α+K×n)th grayscale level only in a predetermined sub-field period of a display period of each of fields.

### BACKGROUND OF THE INVENTION

1. Field of the Invention

The present invention relates to a method and device for driving a display panel such as a plasma display.

2. Description of the Related Art

A plasma display has a plurality of discharge cells arrayed in a matrix, and emits light by exciting a fluorescent material in the discharge cells using the ultraviolet rays generated by a gas discharge in the selected discharge cells. By controlling the frequency of occurrence of gas discharges in the discharge cells per unit time, that is, by controlling the number of times of discharge sustain pulses to be applied to the discharge cells, a halftone image can be displayed. As a driving method for a plasma display, a sub-field method is widely used, which divides one field corresponding to one image into a plurality of sub-fields, sets the ratio of an emission sustain period in each sub-field to power of two, and displays a halftone display by a combination of these sub-fields. For example, if the ratios of the emission sustain periods (that is weights of brightness) of eight sub-fields SF₁, SF₂, . . . , SF₈ are set to 2⁰: 2¹: 2²: 2³: 2⁴: 2⁵: 2⁶: 2⁷, that is 1: 2: 4: 8: 16: 32: 64: 128, then 256 grayscales can be implemented by combinations of the sub-fields. A related art of the sub-field method is disclosed, for example, in Japanese Patent Kokai NO. 2004-4606.

FIG. 1 illustrates an example of emission patterns when weights of four sub-fields SF₁, SF₂, SF₃ and SF₄ are set to 2⁰: 2¹: 2²: 2³, that is 1: 2: 4: 8, respectively. In FIG. 1, the symbol “◯” indicates light emission produced by sustain discharge. A halftone image can be displayed with 16 grayscales from the grayscale level “0” where the discharge cell does not emitted light in all the periods of the sub-fields SF₁-SF₄, to the grayscale level “15” where the discharge cell emit light in all the periods of the sub-fields SF₁-SF₄.

When a plasma display displays a moving image by the sub-field method, a viewer recognizes noise, the so called “false contour” which considerably degrades the image quality. To explain the false contour, it is assumed that the 16 grayscale image is displayed by the combinations of the four sub-fields SF₁-SF₄, as shown in FIG. 1. As FIG. 2 illustrates, it is assumed that there is an image of field 1 including pixels P0-P4 with the grayscale level “7” and including pixels P5-P6 with the grayscale level “8,” and that there is an image of field 2 which is the image of field 1 moved up one pixel. The images of fields 1 and 2 are continuously displayed over time. A human eye or a point of sight has characteristics to follow up a moving luminescent spot, so if the viewer's point of sight follows up sub-fields SF₁-SF₃ which do not emit, when the viewer is watching around the boundary of pixels between the grayscale levels “7” and “8,” a black dot with grayscale level “0” is recognized as noise or a false contour which actually does not exist between pixels with the grayscale level “7” and pixels with grayscale level “8.”

As a driving method capable of reducing the generation of the false contours, a driving method disclosed in Japanese Patent Kokai No. 2000-227778 is known. In this driving method, emission patterns of sub-fields are successive with respect to time and space in one field of the display period, so theoretically the above mentioned false contour is not generated. However a shortcoming of this driving method is that the possible number of grayscales is small.

### SUMMARY OF THE INVENTION

In view of the foregoing, it is an object of the present invention to provide a method and device for driving a display panel which can produce a large number of grayscales, and can considerably suppress the generation of false contours.

According to one aspect of the present invention, there is provided a method of driving a display panel including a plurality of display cells by constructing a display period of each field constituting an image signal using a plurality of sub-field periods to display a halftone image. The method comprises the steps of: (a) when the display cell is lit at a brightness of (α+k×n)th grayscale level (where n is an arbitrary integer of 0 or higher, K is a predetermined integer of 2 or higher, and α is a predetermined integer of 0 or higher but less than K), turning ON the display cell not only in one or more sub-field periods in which a display cell is lit at a brightness of (α+K×(n−1))th grayscale level, but also in at least one sub-field period other than the one or more sub-field periods; and (b) when the display cell is lit at a brightness of an intermediate level between the (α+K×(n−1))th grayscale level and the (α+K×n)th grayscale level, setting the display cell to be a opposite state of a turned ON or turned OFF state at the (α+K×(n-1))th or the (α+K×n)th grayscale level only in a predetermined sub-field period of a display period of each field.

According to another aspect of the present invention, there is provided a device for driving a display panel comprising a plurality of display cells by constructing a display period of each field constituting an image signal using a plurality of sub-field periods to display a halftone image. The device comprises a driver circuit for driving each of the display cells; and a controller for controlling the driver circuit. The controller executes the processing: a first control processing of, when the display cell is lit at a brightness of (α+k×n)th grayscale level (where n is an arbitrary integer of 0 or higher, K is a predetermined integer of 2 or higher, and α is a predetermined integer of 0 or higher but less than K), turning ON the display cell not only in one or more sub-field periods in which a display cell is lit at a brightness of (α+K×(n−1))th grayscale level, but also in at least one sub-field period other than the one or more sub-fields; and a second control processing of, when the display cell is lit at a brightness of an intermediate level between the (α+K×(n−1))th grayscale level and the (α+K×n)th grayscale level, setting the display cell to be a opposite state of a turned ON or turned OFF state at the (α+K×(n−1))th or the (α+K×n)th grayscale level only in a predetermined sub-field period of a display period of each field.

### BRIEF DESCRIPTION OF THE DRAWINGS

FIG. 1 illustrates an example of emission patterns when four sub-fields are used;

FIG. 2 illustrates a false contour;

FIG. 3 is a block diagram depicting a plasma display which is an embodiment of the present invention;

FIG. 4 is a plan view depicting a partial area of a display panel of the plasma display;

FIG. 5 is a cross-sectional view along the 5-5 line of the display panel shown in FIG. 4;

FIG. 6 is a diagram depicting a conventional emission drive format;

FIG. 7 illustrates an example of emission patterns in accordance with the emission drive format shown in FIG. 6;

FIGS. 8A and 9A are diagrams depicting the emission drive format according to one embodiment of the present invention;

FIGS. 8B and 9B are diagrams depicting another emission drive format according to one embodiment of the present invention;

FIG. 10 illustrates a first emission pattern corresponding to the emission drive format shown in FIGS. 8A and 9A;

FIG. 11 illustrates a second emission pattern corresponding to the emission drive format shown in FIGS. 8B and 9B;

FIG. 12 illustrates an applicable example of emission patterns;

FIG. 13 illustrates another applicable example of emission patterns;

FIG. 14 illustrates still another applicable example of emission patterns;

FIG. 15 is a graph depicting a relationship between grayscale levels and brightness levels in accordance with the first emission pattern;

FIG. 16 illustrates an example of a moving image;

FIG. 17 is a graph depicting brightness levels with respect to pixel positions;

FIG. 18 illustrates an example of a moving image; and

FIG. 19 is a graph depicting brightness levels with respect to pixel positions.

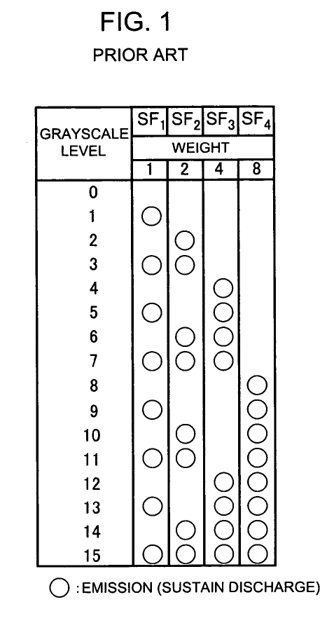

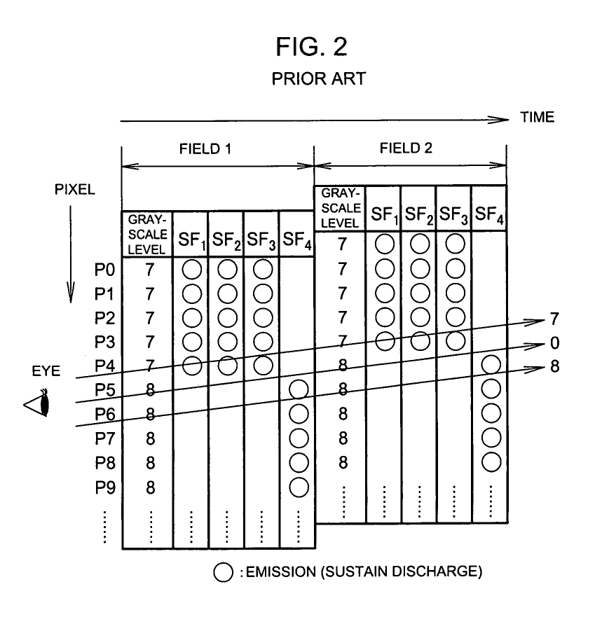

### DETAILED DESCRIPTION OF THE INVENTION

Various embodiments of the present invention will now be described.

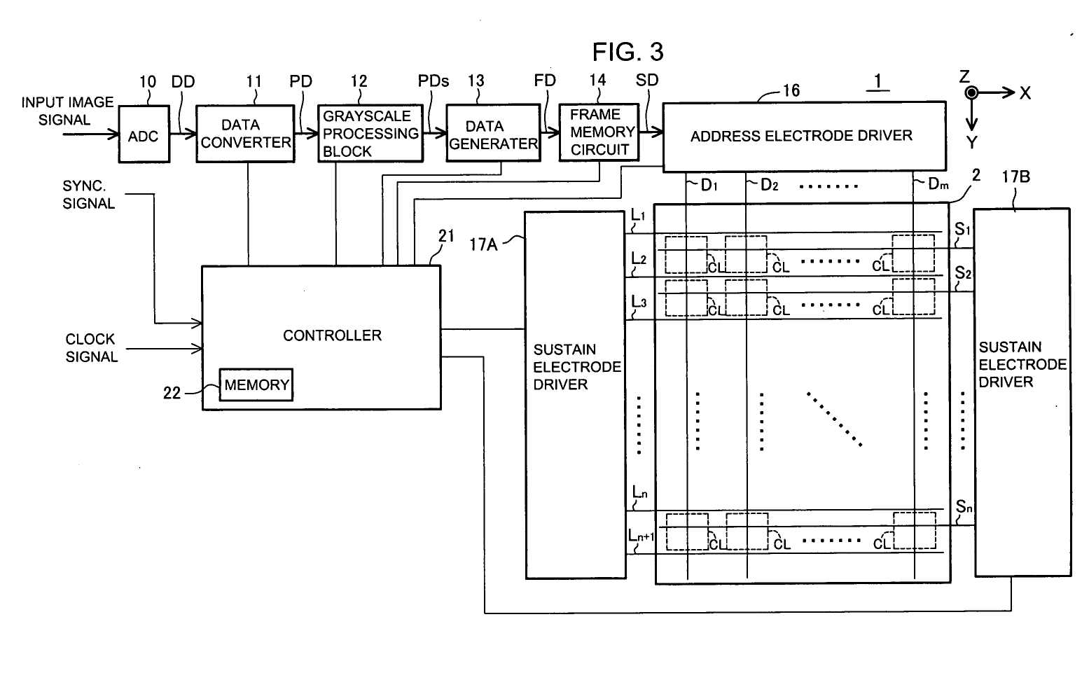

FIG. 3 is a block diagram depicting a plasma display (display device) 1 which is an embodiment of the present invention. This plasma display 1 comprises a display panel (plasma display panel) 2, discharge cells (display cells) CL in the display panel 2, an address electrode driver 16 for driving CL, and sustain electrode drivers 17A and 17B. The plasma display 1 further comprises an A/D converter (ADC) 10, data converter 11, grayscale processing block 12, data generator 13, frame memory circuit 14 and controller 21. The controller 21 controls the processing blocks 11, 12, 13, 14, 16, 17A and 17B using synchronization signals and clock signals which are supplied from an outside source.

An input image signal is comprised of analog R (red), G (green) and B (blue) signals. The A/D converter 10 samples and quantizes the analog R, G and B signals, respectively, for example, so as to generate digital image signals DDs for R, G and B respectively, and supply the digital image signals DDs to the data converter 11. The data converter 11 performs reverse-gamma conversion on the digital image signal DD according to the characteristic curve stored in advance, and outputs the corrected image signal PD with some bit length to the grayscale processing block 12 in accordance with an instruction from the controller 21. The data conversion unit 11 performs reverse-gamma correction on the digital image signal DD with an 8-bit length, and outputs the corrected image signal PD with a 2- to 10-bit length, for example.

The grayscale processing unit 12 generates the image signal PDs by performing error diffusion processing and dither processing on the corrected image signal PD from the data converter 11, and supplies the signal PDs to the data generator 13. For example, when the corrected image signal PD with L bits (L is a positive integer) is input from the data converter 11, the grayscale processing block 12 executes the error diffusion processing for diffusing the lower x bits (x is a positive integer less than L) of the corrected image signal PD into higher L-x bits of the signals of the peripheral pixels, and after adding elements of a dither matrix to the L-x bit signal generated by the error diffusion processing, a right bit shift is executed so as to provide the image signal PDs with higher L-y bits (y is a positive integer less than L-x). The elements of the dither matrix are stored in a memory (not illustrated) in advance.

The data generation circuit 13 generates field data FDs based on the image signal PD supplied from the grayscale processing unit 12, and outputs the field data FDs to the frame memory circuit 14. The frame memory circuit 14 temporarily stores field data FD which was input in the internal buffer memory (not illustrated), and also reads the data stored in the buffer memory in sub-field units, and supplies the data to the address electrode driver 16. The address electrode driver 16 generates address pulses based on the data SD which are input from the frame memory circuit 14, and applies the address pulses to the address electrodes D₁-Dₘ at a predetermined timing.

The display panel 2 is comprised of a plurality of discharge cells CL, CL, . . . which are arrayed in a matrix on a plane; m number of address electrodes D₁, . . . , Dₘ (m is a 2 or higher integer) which extend from the address electrode driver 16 in the Y direction; n+1 number of sustain electrodes L₁, . . . , Lₙ₊₁ (n is a 2 or higher integer) which extend in the X direction which is perpendicular to the Y direction from the first sustain electrode driver 17A; and n number of sustain electrodes S₁, . . . , Sₙ which extend in the -X direction from the second sustain electrode driver 17B. The discharge cells CL are formed in respective areas corresponding to intersections of the address electrodes D₁-Dₘ with the sustain electrodes L₁-Lₙ₊₁, S₁-Sₙ.

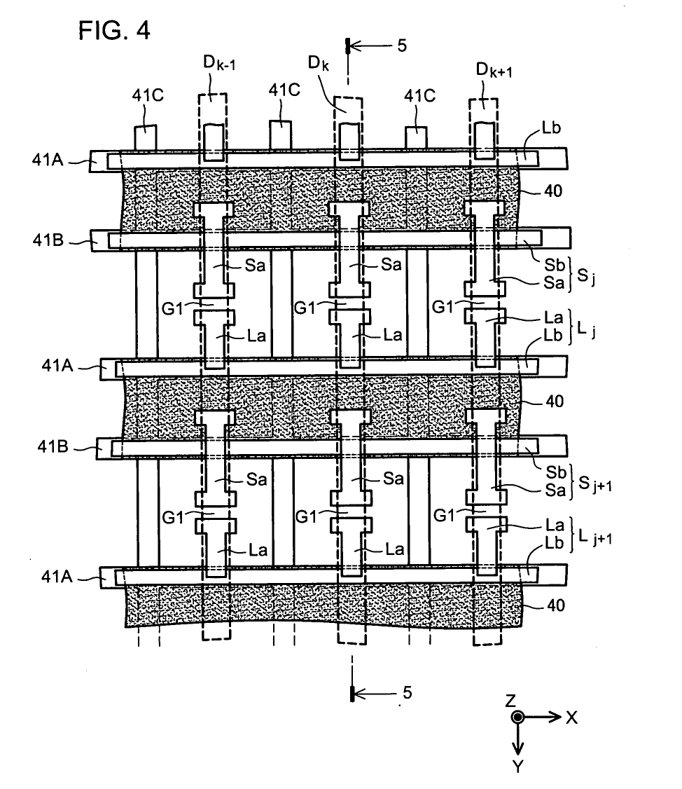

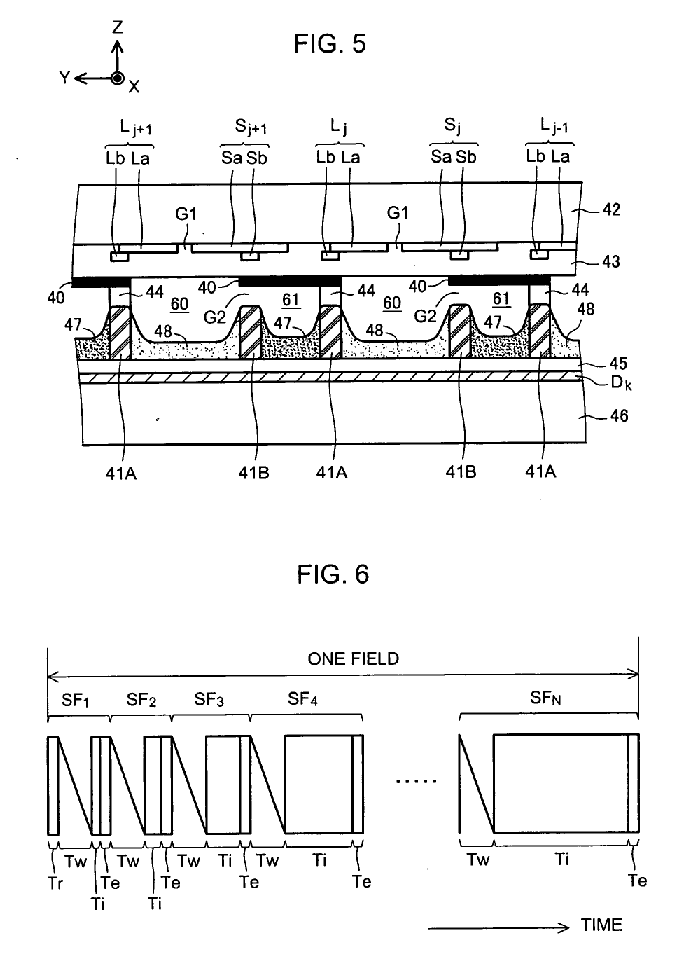

FIG. 4 is a plan view depicting a partial area of the above mentioned display panel 2. FIG. 5 is a cross-sectional view along the 5-5 line of the display panel 2 shown in FIG. 4. Each of sustain electrodes Sⱼ, Sⱼ₊₁ (j is an integer in the 1 to n−1 range) is comprised of a strip type bus electrode Sb which extends in the −X direction and a strip type transparent electrodes Sa, Sa, . . . which is connected to the bus electrode Sb and extends in the Y direction. The transparent electrode Sa is made of transparent conductive material, such as ITO (Indium Tin Oxide), and has T-shaped ends. The bus electrode Sb is made of black or dark colored metal film. Each of the sustain electrodes Lⱼ and Lⱼ₊₁ is comprised of a strip type bus electrode Lb which extends in the X direction and is made of black or dark metal film, and a strip type transparent electrodes La, La, . . . which is connected to the bus electrode Lb and extends in the Y direction. The transparent electrode La is made of such transparent conductive material as ITO, and has T-shaped ends which face one end of the transparent electrode Sa via the discharge gap G1. As FIG. 5 shows, these sustain electrodes Sⱼ, Sⱼ₊₁, Lⱼ, Lⱼ₊₁ are formed on the rear face of the translucent front substrate 42, and the front dielectric layer 43 is formed so as to cover the sustain electrodes Sⱼ, Sⱼ₊₁, Lⱼ, Lⱼ₊₁. On this front dielectric layer 43, light absorbing dielectric layers (black stripes) 40 containing black or dark colored pigment are formed in stripes. On the rear face of the front dielectric layer 43 and the black stripes 40, a protective film (not illustrated) made of MgO (Magnesium Oxide) is formed.

On the back substrate 46 which faces the front substrate 42, on the other hand, strip type address electrodes Dₖ₋₁, Dₖ and Dₖ₊₁ (k is an integer in the 1 to m−1 range) which extend in the Y direction are formed. As FIG. 4 shows, each of the address electrodes Dₖ₋₁, Dₖ and Dₖ₊₁ are disposed so as to face a pair of transparent electrodes Sa and La in the Z direction (depth direction of the front substrate 42). As FIG. 5 shows, the back dielectric layer (protective layer) 45 for coating and protecting these address electrodes Dₖ₋₁, Dₖ and Dₖ₊₁ is formed. On the back dielectric layer 45, ribs 41A, 41B, 41C which are continuous on the X-Y plane are formed. The first ribs 41A, 41A, . . . are formed in stripes directly below the bus electrodes Lb, Lb, . . . in the X direction, and the second ribs 41B, 41B, . . . are created in stripes directly under the bus electrodes Sb, Sb, . . . in the X direction. The dielectric 44 is layered between the first ribs 41A and the black stripe 40. The third ribs 41C, 41C, . . . are formed on the back dielectric layer 45 so as to partition each space above the address electrode along the X direction. As FIG. 4 shows, the main discharge space 60 is formed between the address electrode Dk and a pair of transparent electrodes La, Sa by the ribs 41A, 41B and 41C, and the sub-discharge space 61 is formed between the tip of the transparent electrode Sa and the address electrode Dₖ. The main discharge space 60 and the sub-discharge space 61 are connected via a gap G2 between the black stripe 40 and the second rib 41B. In the main discharge space 60 and the sub-discharge space 61, discharge gases such as Xe (Xenon) which generates ultraviolet rays by discharge are sealed.

On the inner wall facing the sub-discharge space 61, an electron emission layer 47 is formed and is made of secondary electron emission material having relatively low work function, such as MgO (Magnesium Oxide) or BaO (Barium Oxide), for example. On the inner wall facing the main discharge space 60, a fluorescent layer 48, which receives the ultraviolet rays generated by gas discharge and emits light of red (R), green (G) or blue (B), is coated. Each discharge cell CL shown in FIG. 3 corresponds to the area partitioned by the first ribs 41A and the third ribs 41C, and has one main discharge space 60 and one sub-discharge space 61. The structure of the display panel 2 has been described heretofore.

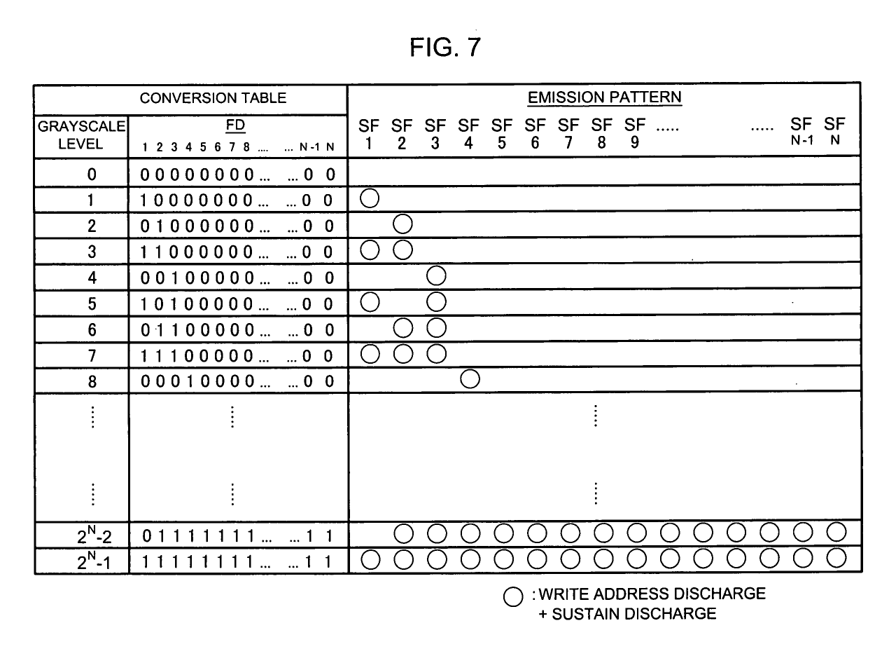

As FIG. 3 shows, the controller 21 can execute drive control-processing according to a plurality of emission drive formats and emission patterns stored in the memory 22. Now a conventional driving method will be described before the description of a driving method of the present embodiment. FIG. 6 is a diagram depicting a conventional emission drive format, and FIG. 7 illustrates emission patterns in accordance with the emission drive format shown in FIG. 6.

As FIG. 6 shows, a display period of one field of an image signal is comprised of N number of periods of sub-fields (sub-field periods) SF₁-SF_{N} (N is a 1 or higher integer), and each of the sub-fields SF₁-SF_{N} has an address period Tw, sustain period Ti and erase period Te. Only the first sub-field SF₁ has a reset period Tr before the address period Tw. It is assumed that the emission sustain periods Ti, Ti, Ti, . . . Ti which are in proportion to the weights of 2⁰, 2¹, 2², . . . , 2^{N} respectively are assigned to the sub-fields SF₁, SF₂, SF₃, . . . , SF_{N} respectively.

In the reset period Tr of the first sub-field SF₁, the controller 21 controls the sustain electrode drivers 17A and 17B to apply the reset pulse to the sustain electrodes L₁-Lₙ₊₁ and S₁-Sₙ, so that reset discharges are generated in all the discharge cells CL of the display panel 2, thus generating wall charges. Then the controller 21 controls the sustain drivers 17A and 17B so as to apply erase pulses to the sustain electrodes L₁-Lₙ₊₁, S₁-Sₙ, thus erasing the wall charges of all the discharge cells CL of the display panel 2 all at once. By this, all discharge cells CL are initialized to the turned OFF state.

In the address period Tw after the reset period Tr, wall charges are selectively stored in the discharge cells CL to be turned ON out of the discharge cells CL of the display panel 2. Specifically, the first sustain electrode driver 17A applies a scanning pulse sequentially to the sustain electrodes L₁-Lₙ₊₁, and the second sustain electrode driver 17B applies a scanning pulse sequentially to the sustain electrodes S₁-Sₙ. The address electrode driver 16 applies address pulses synchronizing these scanning pulses to the address electrodes D₁-Dₘ. By this, a gas discharge (write address discharge) is generated in the discharge spaces 60 and 61 of the display panel 2 shown in FIG. 5. The charges generated in the sub-discharge space 61 move to the main discharge space 60 via the gap G2. As a result, the wall charges are stored in the main discharge space 60.

In the sustain period Ti after the address period Tw, the sustain electrode drivers 17A and 17B apply discharge sustain pulses to the sustain electrodes L₁-Lₙ₊₁ and S₁-Sₙ respectively an assigned number of times. By this, in the discharge cells CL in which wall charges are stored, gas discharges (sustain discharges) are repeatedly generated between the pair of transparent electrodes Sa and La in the main discharge space 60 shown in FIG. 3, the fluorescent layer 48 is excited by ultraviolet rays generated by this discharge, thereby emitting light of R, G or B. In the erase period Te after the sustain period Ti, the controller 21 generates erase discharges in all the discharge cells CL all at once to erase the wall charges.

In the address period Tw of the subsequent sub-field SF₂, wall charges are selectively stored in the discharge cells CL to be turned ON, then in the sustain period Ti, discharge sustain pulses are applied to the discharge cells CL and in the erase period Te, the wall charges are erased from all the discharge cells CL. This process is repeatedly executed in each of the sub-fields SF3-SFN.

The data generator 13 converts the N-bit grayscale corrected image signal PDs from the grayscale processing unit 12, into field data FD comprised of N-bit binary signals according to the conversion table shown in FIG. 7, and outputs the field data FD to the frame memory circuit 14. Specifically, when the grayscale level of the image signal PDs is “0,” all the bits of the field data FD from the least significant bit (LSB) of the first bit to the most significant bit (MSB) of the N-th bit are set to the value “0.” If the grayscale level of the image signal PDs is “k” (k is an integer in the 1 to 2^{N}−1 range), the field data FD having a binary value at this grayscale level k is generated. For example, if the grayscale level is “3”, the field data FD has a value of “000 . . . 011,” and if the grayscale level is “2^{N}−1”, the field data FD has a value of “111 . . . 111.”

The frame memory circuit 14 reads the stored field data FD in sub-field units, and outputs it to the address electrode driver 16. In each address period Tw, the address electrode driver 16 sequentially samples and latches the data SD from the frame memory circuit 14, then generates address pulses in accordance with the emission pattern in FIG. 7 corresponding to the value of the data SD, and applies these address pulses to the address electrodes D₁-Dₘ. In FIG. 7, the symbol “◯” indicates that a write address discharge and a sustain discharge are generated, that is the discharge cell CL is in a turned ON state. The sub-field period in which the symbol “◯” is not present indicates that the discharge cell CL is in a turned OFF state. By a combination of the turned ON states and the turned OFF states in each sub-field period, an emission pattern at each grayscale level is determined. In the case of the emission pattern shown in FIG. 7, the difference of the weighted center of emission (i.e., the difference of the weighted center of brightness with respect to time in the display period of one field) between the grayscale level “7” and the grayscale level “8,” for example, is large, so the above mentioned false contour is generated.

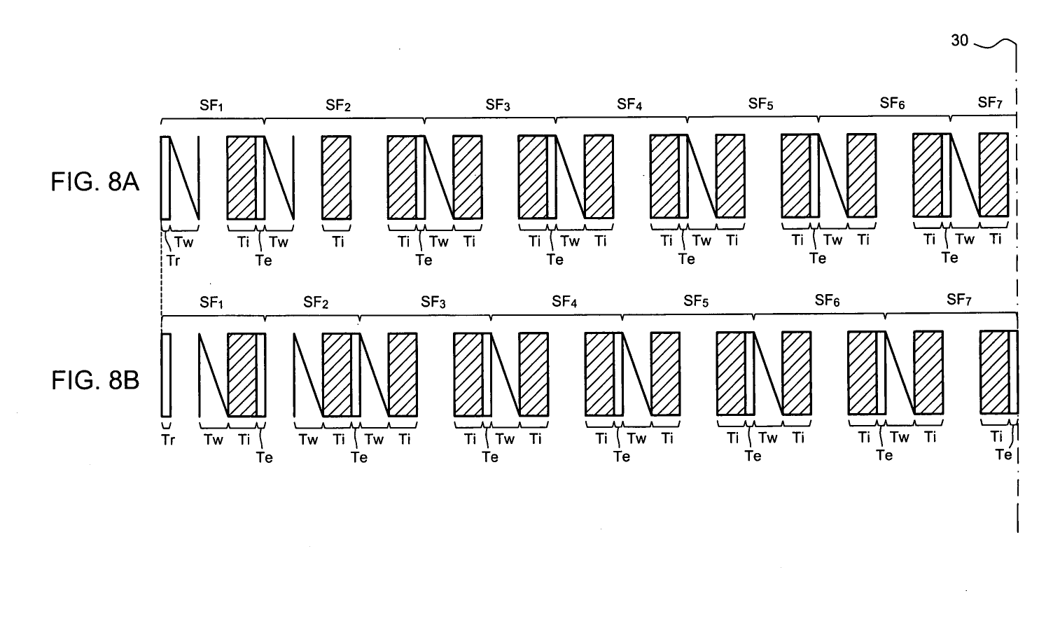

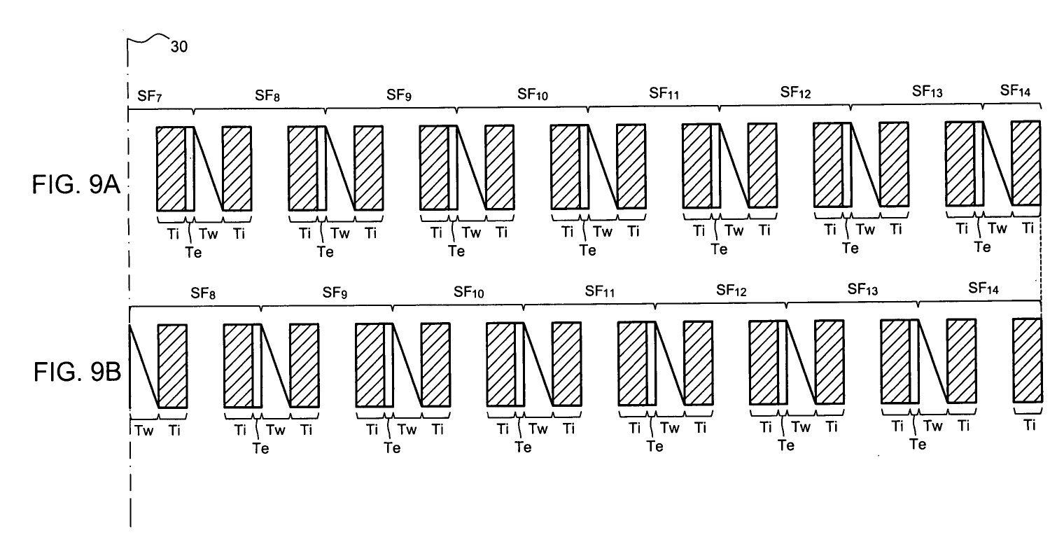

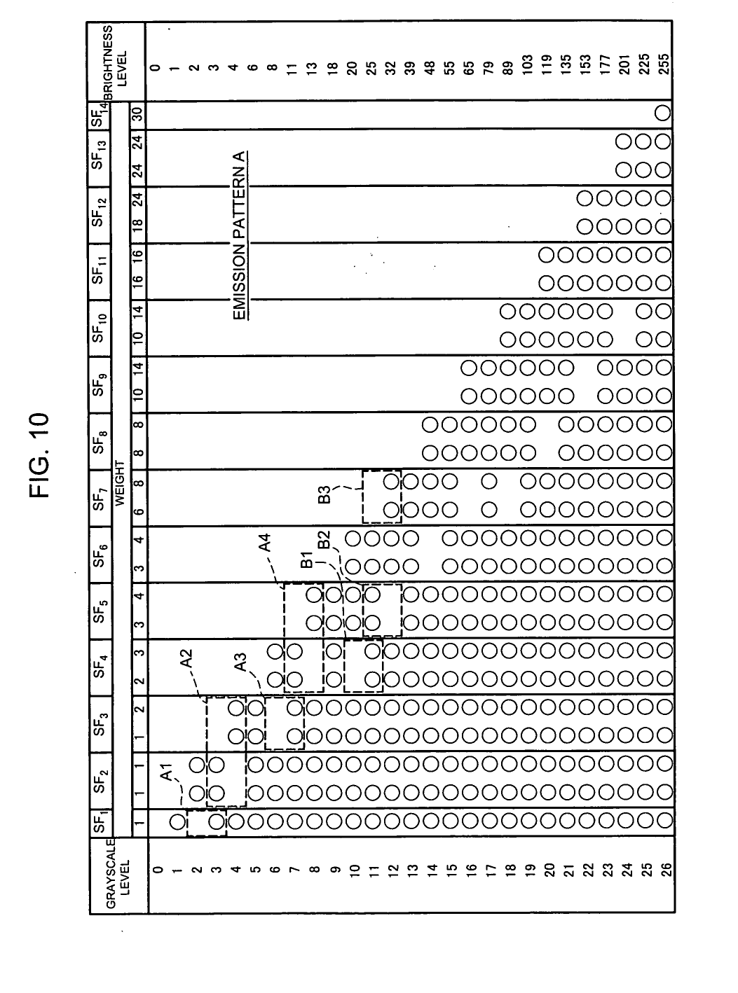

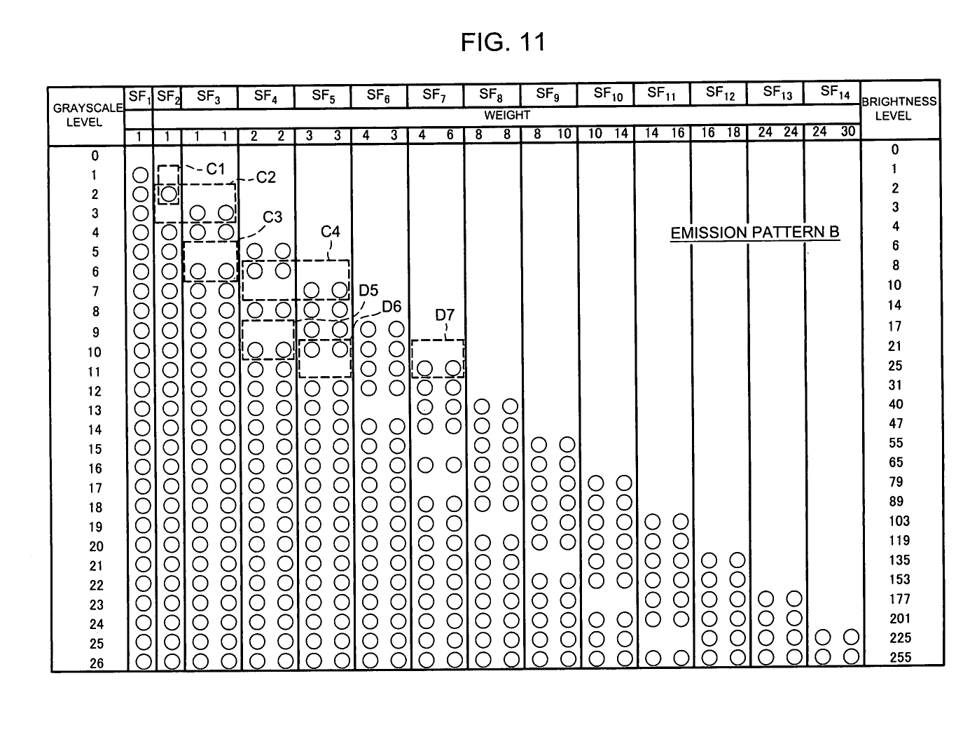

Now the driving method of the present invention will be described. FIGS. 8A, 8B, 9A and 9B are diagrams depicting two types of emission drive formats according to the present embodiment. FIGS. 8A, 8B and FIGS. 9A, 9B are inter-connected via a dash and dotted line 30. FIGS. 8A and 9A illustrate the emission drive format A. FIGS. 8B and 9B illustrate the emission drive format B. FIG. 10 illustrates emission pattern A corresponding to the emission drive format A, and FIG. 11 illustrates emission pattern B corresponding to the emission drive format B.

Referring to FIGS. 8A, 8B, 9A and 9B, in the emission drive formats A and B, the display period of one field of an image signal is comprised of 14 periods of the sub-fields SF₁-SF₁₄. Each of the sub-fields SF₁-SF₁₄ has one address period Tw, one or two sustain periods Ti, and one erase period Te. Only the first sub-field SF₁ has a reset period Tr before the address period Tw. Driving method in the address period Tw, sustain period Ti, erase period Te and reset period Tr is as described above.

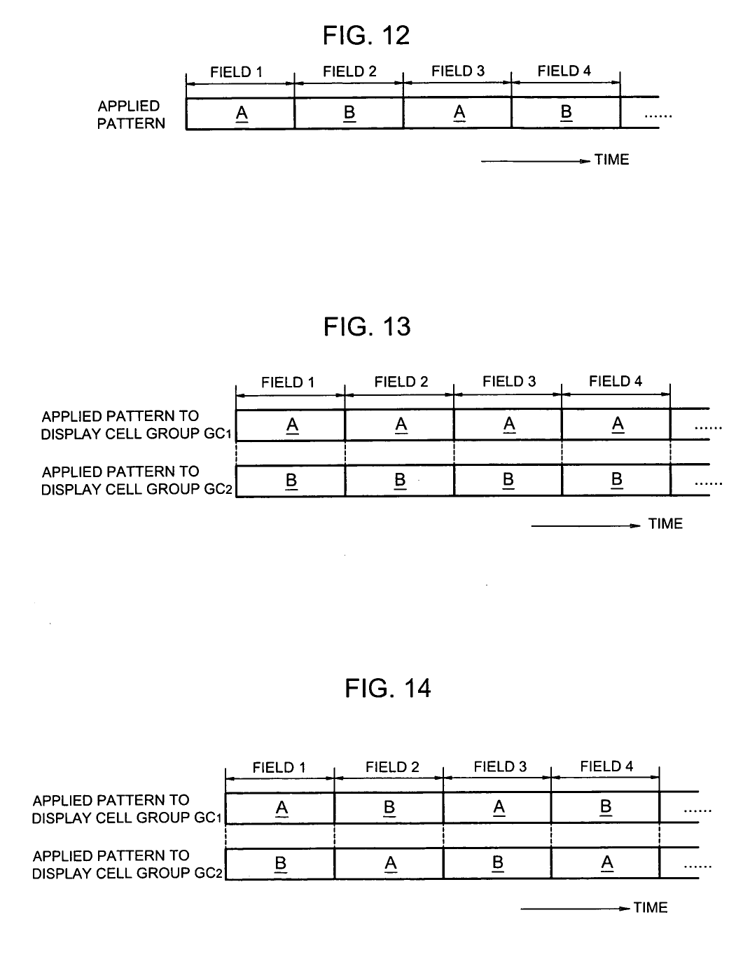

As described below, in order to reduce the false contour, it is preferable to alternately switch between the emission pattern A and the emission pattern B for each field. In other words, as FIG. 12 illustrates, the emission patterns A, B, A, B, . . . are applied to a series of fields 1, 2, 3, 4, . . . , respectively.

The emission pattern A may be applied to the display cell group GC₁ on the even number display line in the horizontal direction of the display panel 2, and the emission pattern B may be applied to the display cell group GC₂ on the odd number display line in the horizontal direction. For example, as FIG. 13 illustrates, in a display period of the series of fields 1, 2, . . . , the emission pattern to be applied to the display cell group GC₁ may be fixed to the emission pattern A, and the emission pattern to be applied to the display cell group GC₂ may be fixed to the emission pattern B.

Otherwise, as FIG. 14 illustrates, in the field 1, the emission pattern A may be applied to the display cell group GC₁, and the emission pattern B may be applied to the display cell group GC₂. In the next field 2, the emission pattern B may be applied to the display group GC₁, and the emission pattern A may be applied to the display cell group GC₂. In the next field 3, the emission pattern A may be applied to the display cell group GC₁, and the emission pattern B may be applied to the display cell group GC₂. In order to reduce the false contour in a moving image, it is preferable to switch the emission patterns being applied to the respective display cell groups GC₁ and GC₂, to the other emission patterns for each subfield, as shown in FIG. 14.

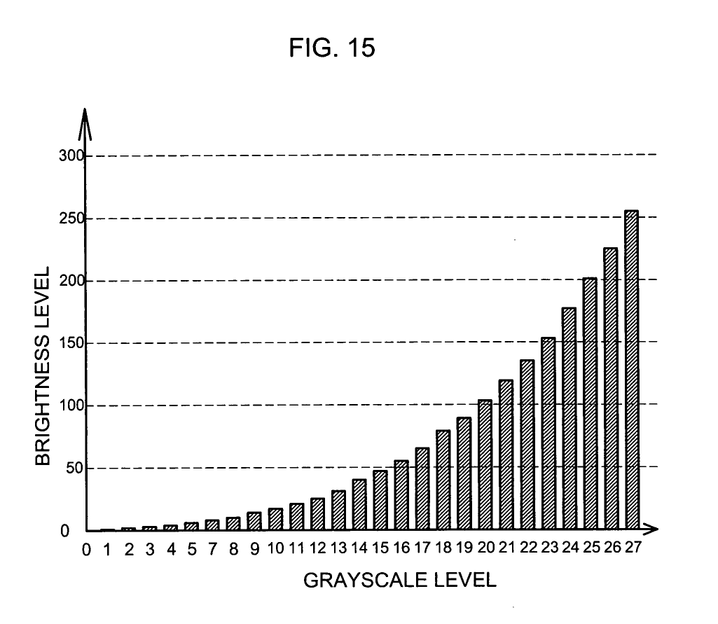

In the emission pattern A shown in FIG. 10, the weights assigned to the sub-fields SF₁, SF₂, SF₃, SF₄, SF₅, SF₆, SF₇, SF₈, SF₉, SF₁₀, SF₁₁, SF₁₂, SF₁₃ and SF₁₄ are respectively “1,” “2 (=1+1),” “3 (=1+2),” “5 (=2+3),” “7 (3+4),” “7 (=3+4),” “14 (=6+8),” “16 (=8+8),” “24 (=10+14),” “24 (=10+14),” “32 (=16+16),” “42 (=18+24),” “48 (=24+24)” and “30.” In the emission pattern B shown in FIG. 11, the weights assigned to the sub-fields SF₁, SF₂, SF₃, SF₄, SF₅, SF₆, SF₇, SF₈, SF₉, SF₁₀, SF₁₁, SF₁₂, SF₁₃ and SF₁₄ are respectively “1,” “1,” “2 (=1+1),” “4 (=2+2),” “6 (=3+3),” “7 (=4+3),” “10 (=4+6),” “16 (=8+8),” “18 (=8+10),” “24 (=14+10),” “30 (=14+16),” “34 (=16+18),” “48 (=24+24)” and “54 (=24+30).” The brightness level corresponding to each grayscale level is a total of the weights of the sub-field periods in the turned ON state (“◯”). For example, in the emission pattern A, the brightness level corresponding to the grayscale level “6” is the total of the weights of periods of sub-field SF₁, SF₂ and SF₄, that is “8 (=1+2+5).” FIG. 15 graphically illustrates brightness levels with respect to grayscale levels in accordance with the emission pattern A.

In the emission drive format A, the emission sustain period of each sub-field, except for the first and last sub-fields SF₁ and SF₁₄, is divided into two periods Ti and Ti, and in the emission drive format B, the emission sustain period of each sub-field, except for the first and second sub-fields SF₁ and SF₂, is divided into two periods Ti and Ti. For example, as FIG. 8A shows, the sustain periods Ti and Ti in the sub-fields SF₂ of the emission drive format A synchronizes with the sustain periods Ti and Ti of the sub-fields SF₂ and SF₃ of the emission drive format B respectively. The erase period Te and the address period Tw of the emission drive format B exist between the sustain periods Ti and Ti of the sub-field SF₂ of the emission drive format A. In this way, in the periods Te and Tw when an erase discharge and a write address discharge are generated in one of the emission drive formats A and B, no discharge is generated in the other format. The discharge sustain periods Ti and Ti of both formats synchronize with each other.

In FIGS. 8A, 8B, 9A and 9B, the length of the sustain period Ti seems to be the same in all the sub-fields SF₁-SF₁₄, but actually a sustain period depending on the weight of each sub-field is assigned to each sustain period Ti.

First, the emission pattern A will be described. When the discharge cell CL is lit at a brightness of (α+K×n)th grayscale level (n is an arbitrary integer of 0 or higher, K is a predetermined integer of 2 or higher, and α is a predetermined integer of 0 or higher but less than K), the controller 21 performs control processing to turn ON the discharge cell CL not only in one or more sub-field periods in which the discharge cell CL is lit at a brightness of the (α+K×(n−1))th grayscale level, but also in at least one sub-fields other than the one or more sub-field periods. If the initial value α is set to “1” and coefficient K is set to “2,” the controller 21 performs the control processing in accordance with the emission pattern A shown in FIG. 10. According to the emission pattern A, the sub-field in which the discharge cell CL is turned ON does not exist at the 0^{th} grayscale level “0,” and at the first grayscale level “1,” a sub-field in which the discharge cell CL is turned ON is only SF₁, and at the (1+2×n)th (n is a 2 or higher integer) odd number grayscale level “3,” “5,” “7,”, . . . , “23” or “25,” the sub-field periods in which the discharge cell CL is turn ON is always successive. For example, when the discharge cell CL is lit at a brightness of the grayscale level “9,” the periods of the sub-fields SF₁-SF₅ in which the discharge cell CL is in the turned ON state are successive, and in this series of sub-field periods, no sub-field period in which the discharge cell CL is in the turned OFF state exists.

The sub-field period in which the discharge cell CL is lit at a brightness of the (1+2×n)th grayscale level is comprised of sub-field periods in which the discharge cell CL is lit at a brightness of the (1+2×(n−1))th grayscale level and one more sub-field period. For example, the sub-field periods in which the discharge cell CL is lit at a brightness of the grayscale level “5” is comprised of the periods of the sub-fields SF₁ and SF₂ in which the discharge cell CL is lit at a brightness of the grayscale level “3” and one more period of the sub-field SF₃.

When the discharge cell CL is lit at a brightness of an intermediate level between the (α+K×(n−1))th grayscale level and the (α+K×n)th grayscale level, the controller 21 executes the control processing to set the discharge cells CL to the opposite state of the turned ON state or the turned OFF state at the (α+K×(n−1))th or (α+K×n)th grayscale level only in a predetermined sub-field period out of the display period of each field. According to the emission pattern A (α=1; K=2), when the discharge cell CL is lit at a brightness of the intermediate level “2×n” between the odd number grayscale levels “1+2×(n−1)” and “1+2×n,” the controller 21 sets the discharge cell CL to the opposite state of the turned ON state or the turned OFF state at the grayscale level “1+2×(n−1)” or “1+2×n” only in one or two sub-field period(s). For example, when the discharge cell CL is lit at a brightness of the intermediate level “2” between the grayscale levels “1” and “3,” the turned OFF state which is the opposite state of the turned ON state at the grayscale level “3” is set only in one period of sub-field SF₁, as shown in area Al in FIG. 10. When the discharge cell CL is lit at a brightness of the intermediate level “4” between the grayscale levels “3” and “5,” the discharge cell CL is set to the opposite states of the turned ON state and the turned OFF state at the grayscale level “3” only in two periods of sub-fields SF₂ and SF₃, as shown in the area A2 in FIG. 10. When the discharge cell CL is lit at a brightness of the intermediate level “6” between the grayscale levels “5” and “7,” the turned OFF state which is the opposite state of the turned ON state at the grayscale level “7” is set only in one period of sub-field SF₃ as shown in the area A3 in FIG. 10. When the discharge cell CL is lit at a brightness of the intermediate level “8” between the grayscale levels “7” and “9,” the opposite state of the turned ON state and the turned OFF state at the grayscale level “7” is set only for two periods of sub-fields SF₄ and SF₅, as shown in the area A4 in FIG. 10.

When the discharge cell CL is lit at a brightness of the intermediate level “10” between the grayscale levels “9” and “11,” the turned OFF state which is the opposite state of the turned ON state at the grayscale level “11” is set only for one period of sub-field SF₄, as shown in the area B1 in FIG. 10. When the discharge cell CL is lit at a brightness of the intermediate level “12” between the grayscale levels “11” and “13,” the opposite state of the turned ON state and the turned OFF state at the grayscale level “11” are set only for two periods of sub-fields SF₅ and SF₇ as shown in the areas B2 and B3 in FIG. 10.

At the intermediate levels “2,” “4,”. . . and “24,” two or more sub-fields in which the discharge cell CL is in the turned OFF state are not successive during the two sub-field periods in which the discharge cell CL is in the turned ON state. For example, as FIG. 10 shows, in the periods of the sub-fields SF₁, SF₂, SF₃, SF₅ and SF₆ in which the discharge cells CL are in the turned ON state at the even number grayscale level “10,” the sub-field period in the turned OFF state is only the period of sub-field SF₄, and two or more sub-field periods in the turned OFF state are not successive in these sub-field periods.

Now the emission pattern B shown in FIG. 11 will be described. As mentioned above, when the discharge cell CL is lit at a brightness of the (α+K×n)th grayscale level, the controller 21 performs control processing to turn ON the discharge cell CL not only in one or more sub-field periods in which the discharge cell CL is lit at a brightness of the (α+K×(n−1))th grayscale level, but also in at least one sub-field period other than the one or more sub-field periods. If the initial value α is set to “0” and the coefficient K is set to “2,” the controller 21 performs control processing in accordance with the emission pattern B. According to the emission pattern B, the sub-field in which the discharge cell CL is turned ON does not exist at the oth grayscale level “0,” and at the first grayscale level “1,” the sub-field in which the discharge cell CL is turned ON is only SF₁, and at the 2×n-th (n is a 1 or higher integer) even number grayscale levels “2,” “4,” . . . , “24” or “26,” the sub-field periods in which the discharge cell CL is turned ON are always successive. For example, when the discharge cell CL is lit at a brightness of the grayscale level “10,” the periods of the sub-fields SF₁-SF₆ in which the discharge cell CL is in the turned ON state are successive, and this series of sub-field periods do not include a sub-field period in which the discharges cell CL are in the turned OFF state.

The sub-field period in which the discharge cell CL is lit at a brightness of the 2×n-th grayscale level is comprised of sub-field periods in which the discharge cell CL is lit at a brightness of the 2×(n−1)th grayscale level and one more sub-field periods. For example, the sub-field period in which the discharge cell CL is lit at a brightness of the grayscale level “6” is comprised of the periods of sub-fields SF₁, SF₂ and SF₃ in which the discharge cell CL is lit at a brightness of the grayscale level “4” and one more period of sub-field SF₄.

As described above, when the discharge cell CL is lit at a brightness of an intermediate level between the (α+K×(n−1))th grayscale level and the (α+K×n)th grayscale level, the controller 21 executes control processing to set the discharge cell CL to the opposite state of the turned ON state or the turned OFF state at the (α+K×(n−1))th or the (α+K×n)th grayscale level only in a predetermined sub-field period out of the display period of each field. According to the emission pattern B (α=0; K=2), when the discharge cell CL is lit at a brightness of the intermediate level “1+2×(n−1)” between the even number grayscale levels “2×(n−1)” and “2×n,” the controller 21 sets the discharge cell CL to the opposite state of the turned ON state or the turned OFF state at the grayscale level “2×(n−1)” or “2×n.” For example, when the discharge cell CL is lit at a brightness of the intermediate level “1” between the grayscale levels “0” and “2,” the opposite state of the turned ON state at the grayscale level “2” is set only in one period of sub-field SF₂, as shown in the area C1 in FIG. 11. When the discharge cell CL is lit at a brightness of the intermediate level “3” between the grayscale levels “2” and “4,” the discharge cell CL is set to the opposite state of the turned ON state and the turned OFF state at the grayscale level “2” only in two periods of sub-fields SF₂ and SF₃, as shown in the area C2 in FIG. 11. When the discharge cell CL is lit at a brightness of the intermediate level “5” between the grayscale levels “4” and “6,” the turned OFF state opposite to the turned ON state at the grayscale level “6” is set only for one period of sub-field SF₃, as shown in the area C3 in FIG. 11. When the discharge cell CL is lit at a brightness of the intermediate level “7” between the grayscale levels “6” and “8,” the opposite state of the turned ON state and the turned OFF state at the grayscale level “6” is set only for two periods of sub-fields SF₄ and SF₅, as shown in the area C4 in FIG. 11.

When the discharge cell CL is lit at a brightness of the intermediate level “9” between the grayscale levels “8” and “10,” the turned OFF state opposite to the turned ON state at the grayscale level “10” is set only for one sub-field SF₄, as shown in the area D5 in FIG. 11. When the discharge cell CL is lit at a brightness of the intermediate level “11” between the grayscale levels “10” and “12,” the opposite state of the turned ON state and the turned OFF state at the grayscale level “10” is set only for two periods of sub-fields SF₅ and SF₇ as shown in the areas D6 and D7 in FIG. 11.

At the intermediate levels “3,” “5,” “7,”. . . and “25,” two or more sub-field periods in which the discharge cell CL is in the turned OFF state are not successive between the two sub-field periods in which the discharge cell CL is in the turned ON state. For example, as FIG. 11 shows, in the periods of the sub-fields SF₁, SF₂, SF₃, SF₅ and SF₆ in the turned ON state at the odd number grayscale level “9,” the sub-field period in the turned OFF state is only the period of sub-field SF₄, and in these sub-field periods, two or more sub-fields periods in the turned OFF state are not successive.

According to the above emission patterns A and B, image display with 27 (=2×14−1) grayscale levels can be performed using 14 sub-fields, SF₁-SF₁₄. If N sub-fields are used (N is a 1 or higher integer), then 2N−1 grayscale levels for display can be produced. Therefore images with a high number of grayscale levels can be displayed.

Also by using the two types of emission patterns A and B, the number of grayscales that can be produced can be increased, and the generation of a false contour can be largely reduced. In other words, in the emission pattern A, the sub-field periods in the emission state at the odd number grayscale levels “3,” “5,”. . . are always successive, and in the case of the even number grayscale levels “2,” “4,” . . . , two or more sub-field periods in the turned OFF state are not successive between the sub-field periods in the turned ON state. In the emission pattern B, the sub-field periods in the turned ON state at the even number grayscale levels “2,” “4,”. . . are always successive, and in the case of the odd number grayscale levels “3,” “5,” . . . , two or more sub-field periods in the turned OFF state are not successive between the sub-field periods in the turned ON state. Therefore the difference of the weighted center of the emission (i.e., the difference of the weighted center of brightness with respect to time in one field of a display period) between adjacent grayscale levels in the same emission pattern is small, so a moving image can be displayed on the plasma display 1 and the generation of false contour noise can be reduced.

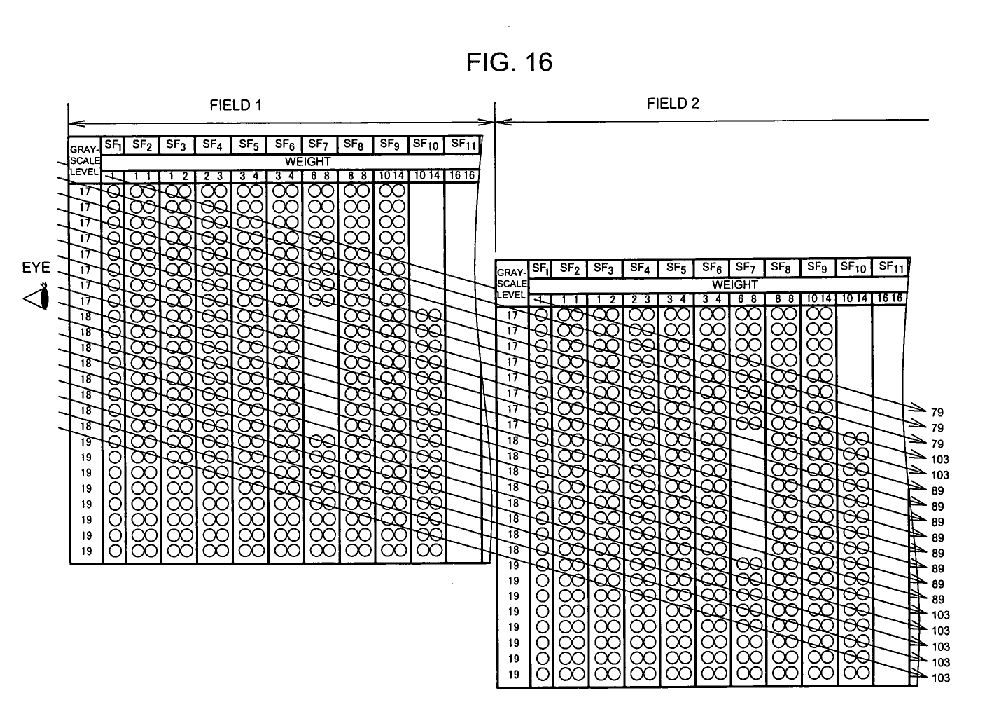

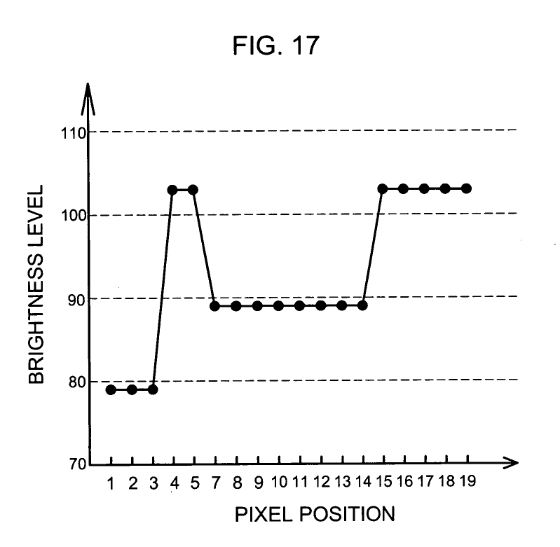

As FIG. 12 shows, false contour noise can be suppressed considerably by alternately switching between the emission patterns A and B for each field. Now it is assumed that the image of the field 1 and the image of the field 2 are displayed successively. As FIG. 16 illustrates, an image of the field 1 is comprised of the pixel area having the grayscale level “17,” the pixel having the grayscale level “18,” and the pixel area having the grayscale level “19.” The image of the field 2 is the image of the field 1 moved down 8 pixels. For both the fields 1 and 2, only the emission pattern A is applied. Human eyes have the characteristic to follow up a moving luminescent spot. When a viewer continuously views the images of the fields 1 and 2 in which the grayscale level or the brightness level gradually changes and the viewer's point of sight moves following up the sub-field SF₇, the viewer averages the brightness levels on the point of sight in the fields 1 and 2, so the pixels having the relatively high brightness level “103” are recognized as the false contour noise between the pixels having the low brightness level “79” and the pixels having the low brightness level “89.” FIG. 17 is a graph depicting a relationship between the pixel position and the brightness level recognized by a viewer when the viewer's point of sight moves as shown in FIG. 16. As this graph shows, the pixels having the brightness level “103” could be recognized as the false contour noise.

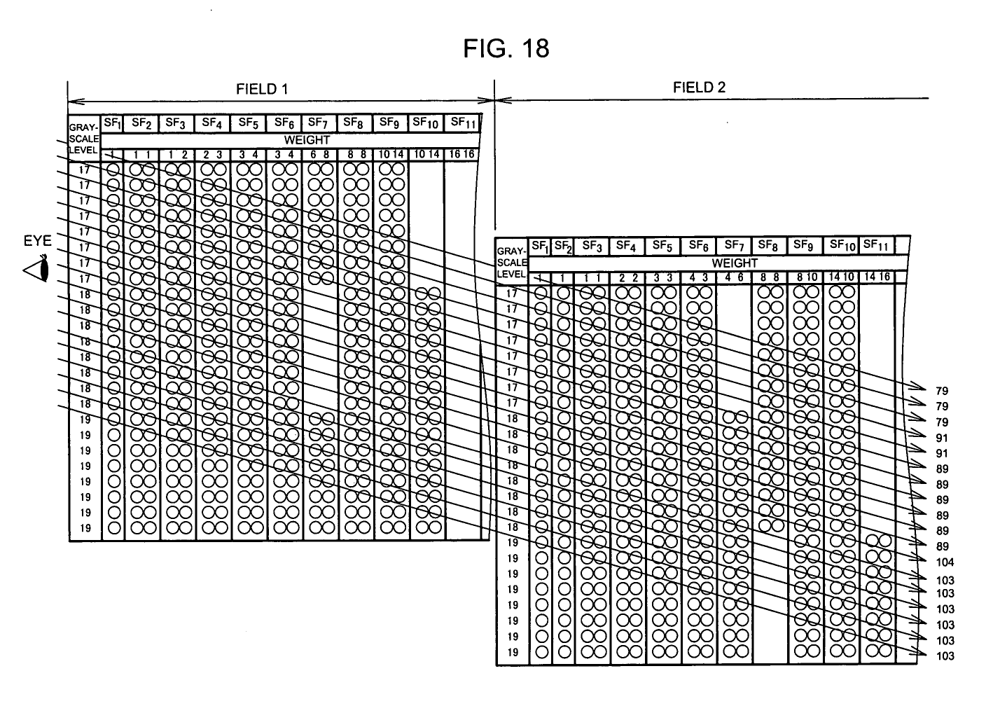

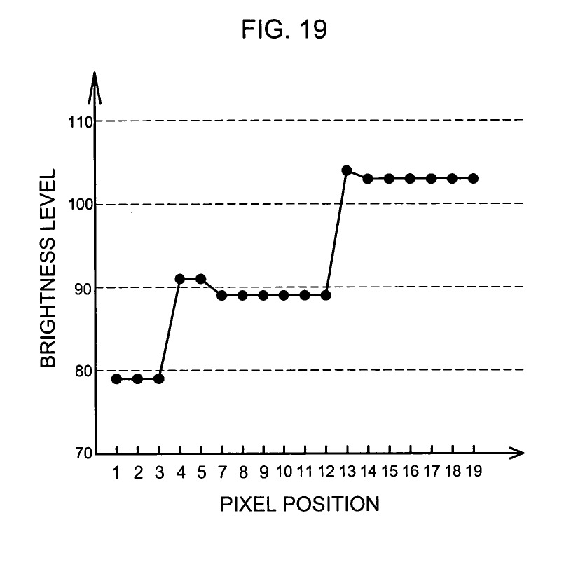

Now the case when the emission pattern A is applied to the field 1 and the emission pattern B is applied to the subsequent field 2 will be described. As FIG. 17 shows, the image in the field 1 is comprised of the pixel area having the grayscale level “17,” the pixel area having the grayscale level “18,” and the pixel area having the grayscale level “19,” and the image of the field 2 is the image of the field 1 moved down 8 pixels. When the viewer views the images of the fields 1 and 2, the viewer recognizes an image of which the brightness level gradually changes, and where the false contour is hardly recognized even if the viewpoint of the viewer moves downward. FIG. 19 is a graph depicting a relationship between pixel positions and brightness levels recognized by a viewer when the viewer's point of sight moves as shown in FIG. 18. As this graph shows, the generation of false contour noise is suppressed considerably.

Also as FIG. 14 shows, the generation of the false contour can be suppressed considerably by switching the emission patterns which are applied to the display cell group GC₁ on the even number display line and the display cell group GC₂ on the odd number display line, to the other emission pattern for each field. In other words, at the even number grayscale levels “2,” “4,”. . . of the emission pattern A, the sub-field periods in the turned OFF state exist between the sub-field periods in the turned ON state and the turned ON state are always successive at the even number grayscale levels “2,” “4,”. . . of the emission pattern B, so at the even number grayscale levels, the emission pattern B can compensate the non-successive turned ON state in the emission pattern A. At the odd number grayscale level “3,” “5,”. . . of the emission pattern B, on the other hand, the sub-field periods in the turned OFF state exist between the sub-fields of the turned ON state and the turned ON state are always successive at the odd number grayscale levels “3,” “5,”. . . of the emission pattern A. Thus, at the odd number grayscale levels, the emission pattern A can compensate the non-successive turned ON state of the emission pattern B. Therefore the generation of false contour noise can be suppressed considerably. And the generation of flicker can also be suppressed.

An embodiment using the emission patterns A and B were described above. As described above, in the emission patterns A and B, the number of the intermediate levels between the (α+K×(n−1))th grayscale level and the (α+K×n)th grayscale level is only one, since the coefficient K is set to “2.” Generally the number of the intermediate levels between the (α+K×(n−1))th grayscale level and the (α+K×n)th grayscale level is K−1, so the number of grayscales can be increased as the coefficient K increases. However, in order to reduce the generation of false contour noise, it is preferable that the sub-fields in the turned ON state where the discharge cell CL is lit continue as long as possible, but at the intermediate level, the sub-field periods in the turned OFF state where the discharge cell CL is not lit exist between the sub-fields in the turned ON state, and a non-successive turned ON state occurs. As the number of intermediate levels increase, the number of sub-field periods in the turned OFF state which exist between the sub-field periods in the turned ON state increases.

Accordingly, in order to reduce the generation of false contour noise, it is preferable to generate an emission pattern of the intermediate level such that the difference of the weighted center of emission between the (α+K×(n−1))th grayscale level and the intermediate level is as small as possible, and such that the difference of the weighted center of emission between the (α+K×n)th grayscale level and the intermediate level is as small as possible.

It is understood that the foregoing description and accompanying drawings set forth the preferred embodiments of the invention at the present time. Various modifications, additions and alternatives will, of course, become apparent to those skilled in the art in light of the foregoing teachings without departing from the spirit and scope of the disclosed invention. Thus it should be appreciated that the invention is not limited to the disclosed embodiments, but may be practiced within the full scope of the appended claims.

This application is based on Japanese patent Application No. 2004-205683, which is hereby incorporated by reference.

What is claimed is:

1. A method of driving a display panel including a plurality of display cells by constructing a display period of each field constituting an image signal using a plurality of sub-field periods to display a halftone image, said method comprising the steps of:
(a) when said display cell is lit at a brightness of (α+k×n)th grayscale level (where n is an arbitrary integer of 0 or higher, K is a predetermined integer of 2 or higher, and a is a predetermined integer of 0 or higher but less than K), turning ON said display cell not only in one or more sub-field periods in which a display cell is lit at a brightness of (α+K×(n−1))th grayscale level, but also in at least one sub-field period other than said one or more sub-field periods; and
(b) when said display cell is lit at a brightness of an intermediate level between said (α+K×(n−1))th grayscale level and said (α+K×n)th grayscale level, setting said display cell to be a opposite state of a turned ON or turned OFF state at said (α+K×(n−1))th or said (α+K×n)th grayscale level only in a predetermined sub-field period of a display period of each said field.

2. The method of driving a display panel according to claim 1, wherein in said step (a), the one or more sub-field periods in which said display cell is lit are successive.

3. The method of driving a display panel according to claim 1, wherein said integer K is set to 2 in said step (a), and said predetermined sub-field period is limited to 1 or 2 sub-field periods in said step (b).

4. The method of driving a display panel according to claim 3, wherein image display with 2N−1 grayscale levels is performed using N (where N is a 2 or higher integer) number of said sub-field periods.

5. The method of driving a display panel according to claim 3, wherein in said step (b), two or more sub-field periods in which said display cell is not lit are not successive between two sub-field periods in which said display cell is lit.

6. The method of driving a display panel according to claim 1, wherein:
a plurality of emission patterns comprising a combination of the turned ON state and the turned OFF state of said display cells in each of said sub-field periods are provided to perform said steps (a) and (b), each said emission pattern corresponding to each of said grayscale levels; and
said method further comprises a step (c) of switching an emission pattern to be applied to another emission pattern at least for each said field.

7. The method of driving a display panel according to claim 6, wherein said step (c) comprises dividing said display cells into a plurality of display cell groups and applying a different emission pattern to each said display cell group.

8. The method of driving a display panel according to claim 7, wherein said step (c) further comprises applying a first emission pattern to a display cell group on an even number display line of said display panel, and applying a second emission pattern which is different from said first emission pattern to a display cell group on an odd number display line of said display panel.

9. The method of driving a display panel according to claim 7, wherein said step (c) further comprises switching from an emission pattern being applied to each of said display cell groups to another emission pattern at least for each said field.

10. The method of driving a display panel according to claim 1, wherein a plasma display panel is driven.

11. A device for driving a display panel comprising a plurality of display cells by constructing a display period of each field constituting an image signal using a plurality of sub-field periods to display a halftone image, said device comprising:
a driver circuit for driving each of said display cells; and
a controller for controlling said driver circuit, said controller executing the processing:
a first control processing of, when said display cell is lit at a brightness of (α+k×n)th grayscale level (where n is an arbitrary integer of 0 or higher, K is a predetermined integer of 2 or higher, and α is a predetermined integer of 0 or higher but less than K), turning ON said display cell not only in one or more sub-field periods in which a display cell is lit at a brightness of (α+K×(n−1))th grayscale level, but also in at least one sub-field period other than said one or more sub-field periods; and
a second control processing of, when said display cell is lit at a brightness of an intermediate level between said (α+K×(n−1))th grayscale level and said (α+K×n)th grayscale level, setting said display cell to be a opposite state of a turned ON or turned OFF state at said (α+K×(n−1))th or said (α+K×n)th grayscale level only in a predetermined sub-field period of a display period of each said field.

12. The device for driving a display panel according to claim 11, wherein in said first control processing, the one or more sub-field periods in which said display cell is lit are successive.

13. The device for driving a display panel according to claim 11, wherein said controller sets said integer K to 2 in said first control processing, and limits said predetermined sub-field period to 1 or 2 sub-field periods in said second control processing.

14. The device for driving a display panel according to claim 11, further comprising a memory storing a plurality of emission patterns comprising a combination of the turned ON state and the turned OFF state of said display cells in each of said sub-field periods for executing said first and second control processing, each said emission pattern corresponding to each of said grayscale levels,
wherein said controller executes a third control processing of switching an emission pattern to be applied to another emission at least for each said field.

15. The device for driving a display panel according to claim 14, wherein said third control processing comprises a control processing of dividing said display cells into a plurality of display cell groups and applying a different emission pattern to each said display cell group.

16. The device for driving a display panel according to claim 15, wherein said third control processing further comprises a control processing of applying a first emission pattern to a display cell group on an even number display line of said display panel, and applying a second emission pattern which is different from said first emission pattern to a display cell group on an odd number display line of said display panel.

17. The device for driving a display panel according to claim 15, wherein said third control processing further comprises a control processing of switching from an emission pattern being applied to each of said display cell groups to another emission pattern at least for each said field.
